(19) United States
(12) Patent Application Publication
(10) Pub. No.: US 2014/0066568 A1
(43) Pub. Date: Mar. 6, 2014

(54) POLYAMIDE RESIN BLENDS

(71) Applicants: JOHN GAVENONIS, WILMINGTON, DE (US); DAVID NEIL MARKS, NEWARK, DE (US); ANNA KUTTY MATHEW, KINGSTON (CA)

(72) Inventors: JOHN GAVENONIS, WILMINGTON, DE (US); DAVID NEIL MARKS, NEWARK, DE (US); ANNA KUTTY MATHEW, KINGSTON (CA)

(73) Assignee: E I DU PONT DE NEMOURS AND COMPANY, Wilmington, DE (US)

(21) Appl. No.: 13/596,185

(22) Filed: Aug. 28, 2012

(51) Int. Cl. C08L 77/06

(52) U.S. Cl. 524/538; 525/432

(57) ABSTRACT

Disclosed is a polyamide resin blend including:
a) 80 to 20 weight percent of a first homopolyamide; and
b) 20 to 80 weight percent of a second homopolyamide that is different from said first homopolyamide;
   wherein the first and second homopolyamides are selected from the group consisting of poly(hexamethylene dodecanediamide) (PA 612), poly(hexamethylene tetradecanediamide) (PA614), poly(hexamethylene hexadecanediamide) (PA616) and poly(hexamethylene octadecanediamide) (PA618). Also disclosed are thermoplastic compositions including the resin blend, and optional components selected from the group: polymeric toughener, functional additive and reinforcing agent; and articles derived from the thermoplastic compositions.

### FIELD OF THE INVENTION

The present invention relates to the field of polyamide blends derived from renewably sourced feedstocks for injection molding and extrusion.

### BACKGROUND OF INVENTION

Polymeric materials, including thermoplastics and thermosets, are used extensively as automotive components and as molded articles for various other applications. They are light weight and relatively easy to mold into complex parts, and are therefore preferred over metals in many such applications. However, a problem encountered by some polymers is salt stress (induced) corrosion cracking (SSCC), where a polymeric part in stress undergoes accelerated corrosion when exposed to inorganic salts. This often results in cracking and premature failure of the molded parts. Polymeric molded parts may also need to exhibit significant high durability and toughness under use conditions.

Polyamides, such as polyamide 66, polyamide 6, polyamide 610 and polyamide 612 have been made into and used as vehicular interior and exterior components and in the form of other parts. While it has been reported that polyamides 610 and 612 are satisfactorily resistant to SSCC (see for instance Japanese Patent 3271325B2), all of these polyamides are prone to SSCC in such uses, because for instance, various sections of vehicles and their components are sometimes exposed to salts, for example sodium chloride or calcium chloride, used to melt snow and ice in colder conditions. Corrosion of metallic parts such as fittings and frame components made from steel and various iron based alloys in contact with water and road salts can also lead to formation of salts. These salts, in turn, can further attack the polyamide based automotive parts, making them susceptible to SSCC. Thus polyamide compositions with improved resistance to SSCC are desired.

U.S. Pat. No. 4,076,664 discloses a terpolyamide resin that has favorable resistance to zinc chloride.

US 2005/0234180 discloses a resin molded article having an excellent snow melting salt resistance, said article comprising 1 to 60% by weight of aromatic polyamide resin.

Furthermore, increasing fossil raw material prices and to reduce greenhouse gas emissions to environment make it desirable to develop engineering polymers from linear, long chain dicarboxylic acids prepared from renewable feedstocks. As such, there is a demand for renewable bio-based polymers having similar or better performance characteristics than petrochemical-based polymers. As example, renewable nylon materials such as PA 610 are based on ricinoleic acid derived sebacic acid (C10). However, ricinoleic acid production requires the processing of castor beans and involves the handling of highly allergenic materials and highly toxic ricin. Moreover, the production of sebacic acid is further burdened with high consumption of energy and with the formation of a large amount of salts as by products associated with other byproducts.

WO 2010/068904 discloses a method to produce renewable alkanes from biomass based triacylglycerides in high yield and selectivity and their subsequent fermentation to renewable diacids. Such naturally occurring triacylglycerides, also referred to as oils and fats, are composed of a glycerol backbone esterified with three fatty acids of a variety of chain lengths specific to the type of fats and oils. Most abundant amongst vegetable oils are triacylglycerides based on C12, 14, 16 and C18 fatty acids. Several vegetable oils are rich in C12, C14, C16 and C18 fatty esters including soybean oil, palm oil, palm kernel oil, sunflower oil, olive oil, cotton seed oil, rape seed oil, and corn oil (Ullmann's Encyclopedia of Technical Chemistry, A. Thomas: “Fats and Fatty Oils” (2005 Wiley-VCH Verlag GmbH & Co. KGaA, Weinheim, electronic version, 10.1002/14356007.a10 173). As such, dioic acid streams based on the oxidative fermentation of renewable alkanes derived from such oils, being rich in C16 and C18 dioic acids, may be useful in formation of economically attractive polymers.

The vegetable oils contain usually at most 50% C12 components (Ullman ref.), hence other diacid components are usually separated out from the mixture of acids and used for other purposes. In order to improve the economics of renewable diacids processes based on triacylglyceride hydrogenation and fermentation of the resulting n-alkanes, it is desirable to include all long chain diacid components into polyamide chains. Hence, developing sustainable compositions of renewable polyamide copolymers, that meet or exceed the performance requirement of existing commercial long chain polyamide compositions at competitive cost is a highly desirable goal.

US patent publication 20011/0220236 A1 discloses a two-layered plastic tubing, the outer layer formed from a mixture comprising a homopolyamide. Preferred homopolyamides are PA 612, PA 610, PA 614 and PA 616.

U.S. Pat. No. 7,858,165 B2 discloses a multi-layer tube including an intermediate layer including a polyamide of formula X, Y/Z in which X denotes residues of an aliphatic diamine having 6 to 10 carbon atoms, and Y denotes residues of an aliphatic dicarboxylic acid having from 10 to 14 carbon atoms; and Z is an optional lactam or amino carboxylic acid.

Chinese Patent application 200810035154 discloses a monolayer tube of aliphatic long-chain polyamide. Disclosed is a polyamide including long chain diamine with 10 to 12 carbon atoms and long-chain diacid with 8 to 10 methylene atoms.

### SUMMARY OF THE INVENTION

One embodiment of the invention is a polyamide resin blend consisting essentially of:
a) 80 to 20 weight percent of a first homopolyamide; and
b) 20 to 80 weight percent of a second homopolyamide that is different from said first homopolyamide;
   wherein said first and second homopolyamides are selected from the group consisting of poly(hexamethylene dodecanediamide) (PA 612), poly(hexamethylene tetradecanediamide) (PA614), poly(hexamethylene hexadecanediamide) (PA616) and poly(hexamethylene octadecanediamide) (PAM).

Another embodiment is a thermoplastic composition comprising:
(A) 30 to 90 weight percent of a polyamide resin blend consisting essentially of (a) 80 to 20 mole percent repeat units of a first homopolyamide; and (b) 20 to 80 mole percent repeat units of a second homopolyamide; wherein said first and second homopolyamides are selected from the group consisting of poly(hexamethylene dodecanediamide), poly(hexamethylene tetradecanediamide), poly(hexamethylene hexadecanediamide) and poly(hexamethylene octadecanediamide).
(B) 0 to 30 weight percent of one or more polymeric tougheners;
(C) 0 to 10 weight percent of one or more functional additives; and
(D) 0 to 60 weight percent of one or more reinforcing agent;
wherein the weight percent of (A), (B), (C) and (D) are based on the total weight of the thermoplastic composition and at least one component of the group consisting of (B), (C), or (D) is present in at least 0.1 weight percent.

### BRIEF DESCRIPTION OF FIGURES

FIG. 1 shows a dynamic mechanical analysis of a crystalline copolymer.

### DETAILED DESCRIPTION OF THE INVENTION

Herein melting points are as determined using differential scanning calorimetry (DSC) at a scan rate of 10° C./min in the first heating scan, wherein the melting point is taken at the maximum of the endothermic peak, and the heat of fusion in Joules/gram (J/g) is the area within the endothermic peak.

Herein freezing points are as determined with DSC in the cooling cycle at a scan rate of 10° C./min carried out after the first heating cycle as per ASTM D3418.

Herein the term delta melting point minus freezing point (MP-FP, in ° C.) is the difference between the melting point and freezing point of a particular polymer or copolymer, wherein the melting point and freezing point are determined as disclosed above. The term delta MP-FP is one measure of the crystallinity of polymer or copolymer and, in part, determines the crystallization kinetics of the polymer or copolymer. A low delta MP-FP typically gives high crystallization rates; and faster cycle times in injection molding process. A low delta MP-FP typically gives desirable high temperature properties in extrusion processing as well.

Dynamic mechanical analysis (DMA) is used herein for determination of storage modulus (E′) and loss modulus (E″), and glass transition, as a function of temperature. Tan delta is a curve resulting from the loss modulus divided by the storage modulus (E″/E′) as a function of temperature.

Dynamic mechanical analysis is discussed in detail in “Dynamic Mechanical Analysis: A practical Introduction,” Menard K. P., CRC Press (2008) ISBN is 978-1-4200-5312-8. Storage modulus (E′), loss modulus (E″) curves exhibit specific changes in response to molecular transitions occurring in the polymeric material in response to increasing temperature. A key transition is called glass transition. It characterizes a temperature range over which the amorphous phase of the polymer transitions from glassy to rubbery state, and exhibits large scale molecular motion. Glass transition temperature is thus a specific attribute of a polymeric material and its morphological structure. For the co-polyamide compositions disclosed herein, the glass transition occurs over a temperature range of about 20 to about 50° C. The Tan delta curve exhibits a prominent peak in this temperature range. This peak tan delta temperature is defined in the art as the tan delta glass transition temperature, and the height of the peak is a measure of the crystallinity of the polymeric material. A polymeric sample with low or no crystallinity exhibits a tall tan delta peak due to large contribution of the amorphous phase molecular motion, while a sample with high level of crystallinity exhibits a smaller peak because molecules in crystalline phase are not able to exhibit such large scale rubbery motion. Thus, herein the value of tan delta glass transition peak is used as a comparative indicator of level of crystallinity in the co-polyamides and melt-blended thermoplastic polyamide compositions.

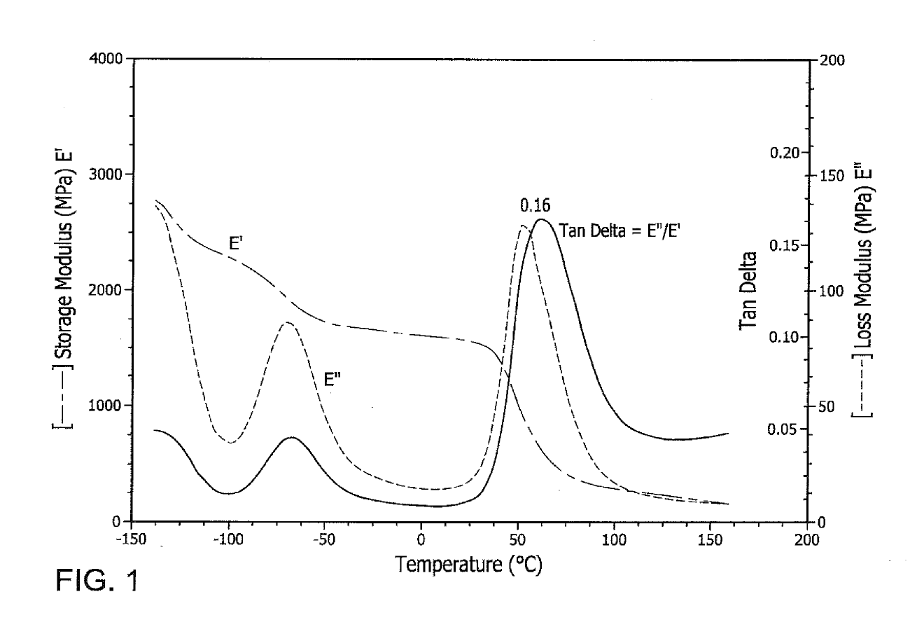

FIG. 1 shows a dynamic mechanical analysis of a crystalline co-polymer showing the storage modulus (E′), loss modulus (E″) curves and computed tan delta curve (E″/E′). A higher tan delta peak corresponds to lower crystallinity and conversely, a lower tan delta peak corresponds to higher crystallinity; as discussed in “Thermal Analysis of Polymers,” Sepe M. P., Rapra Review Reports, Vol. 8, No. 11 (1977).

Herein the polyamide resin blends are designated with abbreviated names separated by a colon (:), and the mole ratio of the repeat units of the polyamides listed thereafter; for instance: PA612:PA614 70:30. Copolymers used in comparative examples are designated as “copolymers” with abbreviated names of the repeat units separated by a slash (/), and the mole ratio of repeat units listed thereafter. For instance: PA612/614 (70/30).

The term “consisting of” means the embodiment necessarily includes the listed components only and no other unlisted components are present. Herein, for instance, the term as applied to the polyamide resin blend means the polyamide resin blend includes the stated homopolyamides and no other polyamide resins.

The term “consisting essentially of” means the embodiment necessarily includes the listed components, but may also include additional unnamed, unrecited elements, which do not materially affect the basic and novel characteristic of the composition. Herein, for instance, the term as applied to polyamide resin blend means the blend includes the stated homopolyamides, but may include other homopolymers in amounts less than 10 mole percent, and preferably less than 3 mole percent, and which do not affect the novel characteristics of the resin as practiced in the polyamide resin blend.

One embodiment of the invention is a polyamide resin blend consisting essentially of:
a) 80 to 20 weight percent of a first homopolyamide; and
b) 20 to 80 weight percent of a second homopolyamide that is different from said first homopolyamide;
   wherein said first and second homopolyamides are selected from the group consisting of poly(hexamethylene dodecanediamide) (PA 612), poly(hexamethylene tetradecanediamide) (PA614), poly(hexamethylene hexadecanediamide) (PA616) and poly(hexamethylene octadecanediamide) (PA618).

In one embodiment the polyamide resin blend has a first homopolyamide that is poly(hexamethylene dodecanediamide) and a second homopolyamide that is poly(hexamethylene tetradecanediamide).

In another embodiment the polyamide resin blend has a first homopolyamide that is poly(hexamethylene tetradecanediamide) and a second homopolyamide that is poly(hexamethylene hexadecanediamide).

In another embodiment the polyamide resin blend has a first homopolyamide that is poly(hexamethylene hexadecanediamide) and a second homopolyamide that is poly(hexamethylene octadecanediamide).

In another embodiment the polyamide resin blend of any of the embodiments disclosed above has a first homopolyamide that is 70 to 30 weight percent; and a second homopolyamide that is 30 to 70 weight percent, of the resin blend.

In other embodiments the polyamide resin blends, as disclosed above, have a salt stress crack resistance of at least 166 hours to failure, as measured with a modified ASTM D1693 method, with the modifications being that 50 weight percent zinc chloride solution is used as the reagent, the test is conducted at 50° C., and rectangular test pieces measuring 50 mm×12 mm×3.2 mm being used. The salt stress crack resistance method is further disclosed in the Methods Section.

The homopolyamides of the invention are preferably prepared from aliphatic dioic acids and aliphatic diamines, at least one of which is bio-sourced or “renewable”. By “bio-sourced” is meant that the primary feed-stock for preparing the dioic acid and/or diamine is a renewable biological source, for instance, vegetable matter including grains, vegetable oils, cellulose, lignin, fatty acids; and animal matter including fats, tallow, oils such as whale oil, fish oils, and the like. These bio-sources of dioic acids and aliphatic diamines have a unique characteristic in that they all possess high levels of the carbon isotope ¹⁴C (carbon pools having an elevated content of ¹⁴C are sometimes referred to as “modern carbon”); as compared to fossil or petroleum sources of the dioic acids and aliphatic diamines. This unique isotope feature remains unaffected by non-nuclear, conventional chemical modifications. Thus the ¹⁴C isotope level in bio-sourced materials provides an unalterable feature that allows any downstream products, such as polyamides; or products comprising the polyamides, to be unambiguously identified as comprising a bio-sourced material. Furthermore, the analysis of ¹⁴C isotope level in dioic acids, diamines and downstream product is sufficiently accurate to verify the percentage of bio-sourced carbon in the downstream product.

The polyamide resin blends can be prepared by cube blending particles of the individual homopolymers into a dry mix. The dry mix may be melt blended in an extruder above the melting point of the highest melting homopolymer. The dry mix may be melt blended as part of an injection molding process using an injection molding machine.

Another embodiment is a thermoplastic composition comprising:
A) 30 to 90 weight percent of a polyamide resin blend consisting essentially of (a) 80 to 20 mole percent repeat units of a first homopolyamide; and (b) 20 to 80 mole percent repeat units of a second homopolyamide; wherein said first and second homopolyamides are selected from the group consisting of poly(hexamethylene dodecanediamide), poly(hexamethylene tetradecanediamide), poly(hexamethylene hexadecanediamide) and poly(hexamethylene octadecanediamide).
B) 0 to 30 weight percent of one or more polymeric tougheners;
C) 0 to 10 weight percent of one or more functional additives; and
D) 0 to 60 weight percent of one or more reinforcing agent;
   wherein the weight percent of (A), (B), (C) and (D) are based on the total weight of the thermoplastic composition and at least one component of the group consisting of (B), (C), or (D) is present in at least 0.1 weight percent.

In one embodiment the thermoplastic composition comprises 0.1 to about 60 weight percent, and preferably about 10 to 60 weight percent, 15 to 50 weight percent and 20 to 45 weight percent, of one or more reinforcement agents. The reinforcement agent may be any filler, but is preferably selected from the group consisting of calcium carbonate, glass fibers with circular cross-section, glass fibers with noncircular cross-section, glass flakes, glass beads, glass balloons, carbon fibers, talc, mica, wollastonite, calcined clay, kaolin, diatomite, magnesium sulfate, magnesium silicate, barium sulfate, titanium dioxide, boron nitrite, sodium aluminum carbonate, barium ferrite, potassium titanate and mixtures thereof. Glass fibers, glass flakes, talc, and mica are preferred reinforcement agents.

In one embodiment the thermoplastic composition comprises 0.1 to 30 weight percent of a polymeric toughener comprising a reactive functional group and/or a metal salt of a carboxylic acid. In another embodiment the thermoplastic composition comprises 2 to 20 weight percent, and preferably 6 to 15 weight %, polymeric toughener selected from the group consisting of: a copolymers of ethylene, glycidyl(meth)acrylate, and optionally one or more (meth)acrylate esters; an ethylene/α-olefin or ethylene/α-olefin/diene copolymer grafted with an unsaturated carboxylic anhydride; a copolymer of ethylene, 2-isocyanatoethyl(meth)acrylate, and optionally one or more (meth)acrylate esters; and a copolymer of ethylene and acrylic acid reacted with a Zn, Li, Mg or Mn compound to form the corresponding ionomer.

The thermoplastic composition may include 0 to 10 weight percent of functional additives such as thermal stabilizers, plasticizers, colorants, lubricants, mold release agents, and the like. Such additives can be added according to the desired properties of the resulting material, and the control of these amounts versus the desired properties is within the knowledge of the skilled artisan

The thermoplastic composition may include a thermal stabilizer selected from the group consisting of polyhydric alcohols having more than two hydroxyl groups and having a number average molecular weight (Mₙ) of less than 2000; one or more polyhydroxy polymer(s) having a number average molecular weight of at least 2000 and selected from the group consisting of ethylene/vinyl alcohol copolymer and polyvinyl alcohol; organic stabilizer(s) selected from the group consisting of secondary aryl amines and hindered amine light stabilizers (HALS), hindered phenols and mixtures of these; copper salts; and mixtures these.

The thermoplastic composition may comprise 0.1 to 10 weight percent, and preferably 1 to 8 weight percent and 2 to 6 weight percent, of one or more polyhydric alcohols having more than two hydroxyl groups and having a number average molecular weight (Mₙ) of less than 2000 of less than 2000 as determined for polymeric materials with gel permeation chromatography (GPC).

Polyhydric alcohols may be selected from aliphatic hydroxylic compounds containing more than two hydroxyl groups, aliphatic-cycloaliphatic compounds containing more than two hydroxyl groups, cycloaliphatic compounds containing more than two hydroxyl groups, aromatic and saccharides.

Preferred polyhydric alcohols include those having a pair of hydroxyl groups which are attached to respective carbon atoms which are separated one from another by at least one atom. Especially preferred polyhydric alcohols are those in which a pair of hydroxyl groups is attached to respective carbon atoms which are separated one from another by a single carbon atom.

Preferably, the polyhydric alcohol used in the thermoplastic composition is pentaerythritol, dipentaerythritol, tripentaerythritol, di-trimethylolpropane, D-mannitol, D-sorbitol and xylitol. More preferably, the polyhydric alcohol used is dipentaerythritol and/or tripentaerythritol. A most preferred polyhydric alcohol is dipentaerythritol.

The thermoplastic composition may comprise 0.1 to 10 weight percent of at least one polyhydroxy polymer having a number average molecular weight (Mₙ) of at least 2000, selected from the group consisting of ethylene/vinyl alcohol copolymers; as determined for polymeric materials with gel permeation chromatography (GPC). Preferably the polyhydroxy polymer has a Mₙ of 5000 to 50,000.

In one embodiment the polyhydroxy polymer is an ethylene/vinyl alcohol copolymer (EVOH). The EVOH may have a vinyl alcohol repeat content of 10 to 90 mol % and preferably 30 to 80 mol %, 40 to 75 mol %, 50 to 75 mol %, and 50 to 60 mol %, wherein the remainder mol % is ethylene. A suitable EVOH for the thermoplastic composition is Soarnol® A or D copolymer available from Nippon Gosei (Tokyo, Japan) and EVAL® copolymers available from Kuraray, Tokyo, Japan.

The thermoplastic composition may comprise 1 to 10 weight percent; and preferably 1 to 7 weight percent and more preferably 2 to 7 weight percent polyhydroxy polymer based on the total weight of the thermoplastic polyamide composition.

The thermoplastic composition may comprise 0 to 3 weight percent of one or more co-stabilizer(s) having a 10% weight loss temperature, as determined by thermogravimetric analysis (TGA), of greater than 30° C. below the melting point of the polyamide resin, if a melting point is present, or at least 250° C. if said melting point is not present, selected from the group consisting of secondary aryl amines, hindered phenols and hindered amine light stabilizers (HALS), and mixtures thereof.

For the purposes of this invention, TGA weight loss will be determined according to ASTM D 3850-94, using a heating rate of 10° C./min, in air purge stream, with an appropriate flow rate of 0.8 mL/second. The one or more co-stabilizer(s) preferably has a 10% weight loss temperature, as determined by TGA, of at least 270° C., and more preferably 290° C., 320° C., and 340° C., and most preferably at least 350° C.

In various embodiments the one or more co-stabilizers preferably are present at 0.1 to 3 weight percent, more preferably at 0.2 to 1.2 weight percent; or more preferably from 0.5 to 1.0 weight percent, based on the total weight of the thermoplastic composition.

Secondary aryl amines useful in the invention are high molecular weight organic compound having low volatility. Preferably, the high molecular weight organic compound will be selected from the group consisting of secondary aryl amines further characterized as having a molecular weight of at least 260 g/mol and preferably at least 350 g/mol, together with a 10% weight loss temperature as determined by thermogravimetric analysis (TGA) of at least 290° C., preferably at least 300° C., 320° C., 340° C., and most preferably at least 350° C.

By secondary aryl amine is meant an amine compound that contains two carbon radicals chemically bound to a nitrogen atom where at least one, and preferably both carbon radicals, are aromatic. Preferably, at least one of the aromatic radicals, such as, for example, a phenyl, naphthyl or heteroaromatic group, is substituted with at least one substituent, preferably containing 1 to about 20 carbon atoms.

Examples of suitable secondary aryl amines include 4,4′di(α,α-dimethylbenzyl)diphenylamine available commercially as Naugard 445 from Uniroyal Chemical Company, Middlebury, Conn.; the secondary aryl amine condensation product of the reaction of diphenylamine with acetone, available commercially as Aminox from Uniroyal Chemical Company; and para-(paratoluenesulfonylamido) diphenylamine also available from Uniroyal Chemical Company as Naugard SA. Other suitable secondary aryl amines include N,N′-di-(2-naphthyl)-p-phenylenediamine, available from ICI Rubber Chemicals, Calcutta, India. Other suitable secondary aryl amines include 4,4′-bis(α,α′-tertiaryoctyl)diphenylamine, 4,4′-bis(α-methylbenzhydryl)diphenylamine, and others from EP 0509282 B1.

The hindered amine light stabilizers (HALS) may be one or more hindered amine type light stabilizers (HALS). HALS are compounds of the following general formulas and combinations thereof:

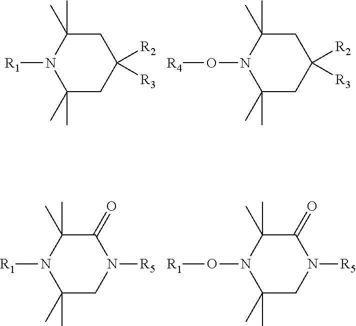

In these formulas, R₁ up to and including R₅ are independent substituents. Examples of suitable substituents are hydrogen, ether groups, ester groups, amine groups, amide groups, alkyl groups, alkenyl groups, alkynyl groups, aralkyl groups, cycloalkyl groups and aryl groups, in which the substituents in turn may contain functional groups; examples of functional groups are alcohols, ketones, anhydrides, imines, siloxanes, ethers, carboxyl groups, aldehydes, esters, amides, imides, amines, nitriles, ethers, urethanes and any combination thereof. A hindered amine light stabilizer may also form part of a polymer or oligomer.

Preferably, the HALS is a compound derived from a substituted piperidine compound, in particular any compound derived from an alkyl-substituted piperidyl, piperidinyl or piperazinone compound, and substituted alkoxypiperidinyl compounds. Examples of such compounds are: 2,2,6,6-tetramethyl-4-piperidone; 2,2,6,6-tetrametyl-4-piperidinol; bis-(1,2,2,6,6-pentamethyl piperidyl)-(3′,5′-di-tert-butyl-4′-hydroxybenzyl)butylmalonate; di-(2,2,6,6-tetramethyl-4-piperidyl)sebacate (Tinuvin® 770, MW 481); oligomer of N-(2-hydroxyethyl)-2,2,6,6-tetramethyl-4-piperidinol and succinic acid (Tinuvin® 622); oligomer of cyanuric acid and N,N-di(2,2,6,6-tetramethyl-4-piperidyl)-hexamethylene diamine; bis-(2,2,6,6-tetramethyl-4-piperidinyl)succinate; bis-(1-octyloxy-2,2,6,6-tetramethyl-4-piperidinyl)sebacate (Tinuvin® 123); bis-(1,2,2,6,6-pentamethyl-4-piperidinyl)sebacate (Tinuvin® 765); Tinuvin® 144; Tinuvin® XT850; tetrakis-(2,2,6,6-tetramethyl-4-piperidyl)-1,2,3,4-butane tetracarboxylate; N,N′-bis-(2,2,6,6-tetramethyl-4-piperidyl)-hexane-1,6-diamine (Chimasorb® T5); N-butyl-2,2,6,6-tetramethyl-4-piperidinamine; 2,2′-[(2,2,6,6-tetramethyl-piperidinyl)-imino]-bis-[ethanol]; poly((6-morpholine-5-triazine-2,4-diyl)(2,2,6,6-tetramethyl-4-piperidinyl)-iminohexamethylene-(2,2,6,6-tetramethyl-4-piperidinyl)-imino) (Cyasorb® UV 3346); 5-(2,2,6,6-tetramethyl-4-piperidinyl)-2-cyclo-undecyl-oxazole) (Hostavin® N20); 1,1′-(1,2-ethane-di-yl)-bis-(3,3′,5,5′-tetramethyl-piperazinone); 8-acetyl-3-dothecyl-7,7,9,9-tetramethyl-1,3,8-triazaspiro(4,5)decane-2,4-dione; polymethylpropyl-3-oxy-[4(2,2,6,6-tetramethyl)-piperidinyl]siloxane (Uvasil® 299); 1,2,3,4-butane-tetracarboxylic acid-1,2,3-tris(1,2,2,6,6-pentamethyl-4-piperidinyl)-4-tridecylester; copolymer of alpha-methylstyrene-N-(2,2,6,6-tetramethyl-4-piperidinyl)maleimide and N-stearyl maleimide; 1,2,3,4-butanetetracarboxylic acid, polymer with beta,beta,beta′,beta′-tetramethyl-2,4,8,10-tetraoxaspiro[5.5]undecane-3,9-diethanol, 1,2,2,6,6-pentamethyl-4-piperidinyl ester (Mark® LA63); 2,4,8,10-tetraoxaspiro[5.5]undecane-3,9-diethanol,beta,beta,beta′,beta′-tetramethyl-polymer with 1,2,3,4-butanetetracarboxylic acid, 2,2,6,6-tetramethyl-4-piperidinyl ester (Mark® LA68); D-glucitol, 1,3:2,4-bis-O-(2,2,6,6-tetramethyl-4-piperidinylidene)-(HALS 7); oligomer of 7-oxa-3,20-diazadispiro[5.1.11.2]-heneicosan-21-one-2,2,4,4-tetramethyl-20-(oxiranylmethyl) (Hostavin® N30); propanedioic acid, [(4-methoxyphenyl)methylene]-,bis(1,2,2,6,6-pentamethyl-4-piperidinyl)ester (Sanduvor® PR 31); formamide, N,N′-1,6-hexanediylbis[N-(2,2,6,6-tetramethyl-4-piperidinyl (Uvinul® 4050H); 1,3,5-triazine-2,4,6-triamine, N,N′″-[1,2-ethanediylbis[[[4,6-bis[butyl(1,2,2,6,6-pentamethyl-4-piperidinyl)amino]-1,3,5-triazine-2-yl]imino]-3,1-propanediyl]]-bis[N′,N″-dibutyl-N′,N″-bis(1,2,2,6,6-pentamethyl-4-piperidinyl) (Chimassorb® 119 MW 2286); poly[[6[(1,1,3,33-tetramethylbutyl)amino]-1,3,5-triazine-2,4-diyl][(2,2,6,6-tetramethyl-4-peperidinyl)-imino]-1,6-hexanediyl[(2,2,6,6-tetramethyl-4-piperidinyl)imino]] (Chimassorb® 944 MW 2000-3000); 1,5-dioxaspiro(5,5) undecane 3,3-dicarboxylic acid, bis(2,2,6,6-tetramethyl-4-peridinyl)ester (Cyasorb®UV-500); 1,5-dioxaspiro(5,5) undecane 3,3-dicarboxylic acid, bis(1,2,2,6,6-pentamethyl-4-peridinyl)ester (Cyasorb® UV-516); N-2,2,6,6-tetramethyl-4-piperidinyl-N-amino-oxamide; 4-acryloyloxy-1,2,2,6,6-pentamethyl-4-piperidine. 1,5,8,12-tetrakis[2′,4′-bis(1″,2″,2″,6″,6″-pentamethyl-4″-piperidinyl(butyl)amino)-1′,3′,5′-triazine-6′-yl]-1,5,8,12-tetraazadodecane; HALS PB-41 (Clariant Huningue S. A.); Nylostab® S-EED (Clariant Huningue S. A.); 3-dodecyl-1-(2,2,6,6-tetramethyl-4-piperidyl)-pyrrolidin-2,5-dione; Uvasorb® HA88; 1,1′-(1,2-ethane-di-yl)-bis-(3,3′,5,5′-tetra-methyl-piperazinone) (Good-rite® 3034); 1,1′1″-(1,3,5-triazine-2,4,6-triyltris ((cyclohexylimino)-2,1-ethanediyl)tris(3,3,5,5-tetramethylpiperazinone) (Good-rite® 3150) and; 1,1′,1″-(1,3,5-triazine-2,4,6-triyltris((cyclohexylimino)-2,1-ethanediyl)tris(3,3,4,5,5-tetramethylpiperazinone) (Good-rite® 3159). (Tinuvin® and Chimassorb® materials are available from Ciba Specialty Chemicals; Cyasorb® materials are available from Cytec Technology Corp.; Uvasil® materials are available from Great Lakes Chemical Corp.; Saduvor®, Hostavin®, and Nylostab® materials are available from Clariant Corp.; Uvinul® materials are available from BASF; Uvasorb® materials are available from Partecipazioni Industriali; and Good-rite® materials are available from B.F. Goodrich Co. Mark® materials are available from Asahi Denka Co.)

Other specific HALS are selected from the group consisting or di-(2,2,6,6-tetramethyl-4-piperidyl)sebacate (Tinuvin® 770, MW 481) Nylostab® S-EED (Clariant Huningue S. A.); 1,3,5-triazine-2,4,6-triamine, N,N′″-[1,2-ethanediylbis [[[4,6-bis[butyl(1,2,2,6,6-pentamethyl-4-piperidinyl)amino]-1,3,5-triazine-2-yl]imino]-3,1-propanediyl]]-bis[N′,N″-dibutyl-N′,N″-bis(1,2,2,6,6-pentamethyl-4-piperidinyl) (Chimassorb® 119 MW 2286); and poly[[6-[(1,1,3,33-tetramethylbutyl)amino]-1,3,5-triazine-2,4-diyl][(2,2,6,6-tetramethyl-4-peperidinyl)-imino]-1,6-hexanediyl[(2,2,6,6-tetramethyl-4-piperidinyl)imino]] (Chimassorb® 944 MW 2000-3000).

Mixtures of secondary aryl amines and HALS may be used. A preferred embodiment comprises at least two co-stabilizers, at least one selected from the secondary aryl amines; and at least one selected from the group of HALS, as disclosed above, wherein the total weight percent of the mixture of co-stabilizers is at least 0.5 wt percent, and preferably at least 0.9 weight percent.

By hindered phenol is meant an organic compound containing at least one phenol group wherein the aromatic moiety is substituted at least at one and preferably at both positions directly adjacent to the carbon having the phenolic hydroxyl group as a substituent. The substituents adjacent the hydroxyl group are alkyl radicals suitably selected from alkyl groups having from 1 to 10 carbon atoms, and preferably will be tertiary butyl groups. The molecular weight of the hindered phenol is suitably at least about 260, preferably at least about 500, more preferably at least about 600. Most preferred are hindered phenols having low volatility, particularly at the processing temperatures employed for molding the formulations, and may be further characterized as having a 10% TGA weight loss temperature of at least 290° C., preferably at least 300° C., 320° C., 340° C., and most preferably at least 350° C.

Suitable hindered phenol compounds include, for example, tetrakis (methylene (3,5-di-(tert)-butyl-4-hydroxyhydrocinnamate)) methane, available commercially as Irganox® 1010 from CIBA Specialty Chemicals, Tarrytown, N.Y. and N,N′-hexamethylene bis(3,5-di-(tert)butyl-hydroxyhydro-cinnamamide) also available from CIBA Specialty Chemicals as Irganox® 1098. Other suitable hindered phenols include 1,3,5-trimethyl-2,4,6-tris(3,5-di-(tert)-butyl-4-hydroxybenzyl)benzene and 1,6hexamethylene bis(3,5-di-(tert)butyl-4-hydroxy hydrocinnamate), both available from CIBA Specialty Chemicals as Irganox® 1330 and 259, respectively. A preferred co-stabilizer for the polyamide composition is a hindered phenol. Irganox 1098 is a most preferred hindered phenol for the compositions.

Mixtures of polyhydric alcohols, secondary aryl amines, hindered phenols, and HALS may be used. A preferred embodiment includes at least one polyhydric alcohol and at least one secondary aryl amine in the weight ranges defined above.

The thermoplastic composition may comprise about 0.1 to at or about 1 weight percent, or more preferably from at or about 0.1 to at or about 0.7 weight percent, based on the total weight of the polyamide composition, of copper salts. Copper halides are mainly used, for example CuI, CuBr, Cu acetate and Cu naphthenate. Cu halides in combination with alkali halides such as KI, KBr or LiBr may be used. Copper salts in combination with at least one other stabilizer selected from the group consisting of polyhydric alcohols, polyhydric polymers, secondary aryl amines and HALS; as disclosed above, may be used as thermal stabilizers.

The thermoplastic composition may comprise a plasticizer(s), preferably one that is miscible with the polyamide. Examples of suitable plasticizers include sulfonamides, preferably aromatic sulfonamides such as benzenesulfonamides and toluenesulfonamides. Examples of suitable sulfonamides include N-alkyl benzenesulfonamides and toluenesulfonamides, such as N-butylbenzenesulfonamide, N-(2-hydroxypropyl)benzenesulfonamide, N-ethyl-o-toluenesulfonamide, N-ethyl-p-toluenesulfonamide, o-toluenesulfonamide, p-toluenesulfonamide, and the like. Preferred are N-butylbenzenesulfonamide, N-ethyl-o-toluenesulfonamide, and N-ethyl-p-toluenesulfonamide.

Further examples of plasticizers include polyamide oligomers with a number average molecular weight of 800 to 5000 g/mol, as disclosed in U.S. Pat. No. 5,112,908, herein incorporated by reference, and US patent publication 2009/0131674 A1. Preferred polyamide oligomers have an inherent viscosity less than 0.5.

The plasticizer may be incorporated into the composition by melt-blending the polyamide resin blend with plasticizer and, optionally, other ingredients, or during polymerization. If the plasticizer is incorporated during polymerization, the polyamide monomers are blended with one or more plasticizers prior to starting the polymerization cycle and the blend is introduced to the polymerization reactor. Alternatively, the plasticizer can be added to the reactor during the polymerization cycle.

When used, the plasticizer will be present in the composition in about 1 to about 20 weight percent, or more preferably in about 6 to about 18 weight percent, or yet more preferably in about 8 to about 15 weight percent, wherein the weight percentages are based on the total weight of the composition.

Herein the thermoplastic composition is compounded by a melt-blending method, in which the ingredients are appropriately dispersed in a polymer matrix during the compounding process. Any melt-blending method may be used for mixing the ingredients and the polymeric materials of the present invention. For example, polymeric material and the ingredients may be fed into a melt mixer through a single feeder or multiple feeders of a single screw extruder or twin screw extruder, agitator, kneader, or Banbury mixer, and the addition of all the components may be carried out in a single cycle process or by batch process in a multiple cycles. When the polymeric material and different ingredients are added in batches in multiple cycles, a part of the polymeric material and/or ingredients are first melt blended, and in subsequent stages melt blended products are further melt-mixed with the remaining polymeric materials and/or ingredients until an adequately mixed composition is obtained. If a reinforcing filler presents a long physical shape (for example, a long glass fiber), drawing extrusion molding or pultrusion process may be used to prepare a reinforced composition.

In another aspect, the present invention relates to a method for manufacturing an article by shaping the melt-mixed compositions. Examples of articles are films, laminates, filaments, fibers, monolayer tubes, hoses, pipes, multi-layer tubes, hoses and pipes with one or more layers formed from the above composition, and automotive parts including engine parts. By “shaping”, it is meant any shaping technique, such as for example extrusion, injection molding, thermoform molding, compression molding, blow molding, filament spinning, sheet casting or film blowing. Preferably, the article is shaped by extrusion or injection molding.

Another embodiment is a molded or extruded thermoplastic article comprising the thermoplastic composition disclosed above. The molded or extruded thermoplastic articles disclosed herein may have application in many vehicular components that meet one or more of the following requirements: high impact strength; high flexural strength; significant weight reduction (over conventional metals, for instance); resistance to high temperature; resistance to light; resistance to oil; resistance to chemical agents such as coolants and road salts; and noise reduction allowing more compact and integrated design. Specific molded or extruded thermoplastic articles are selected from the group consisting of fasteners; fenders; gears; charge air coolers (CAC); cylinder head covers (CHC); oil pans; engine cooling systems, including thermostat and heater housings and coolant pumps; exhaust systems including mufflers and housings for catalytic converters; air intake manifolds (AIM); and timing chain belt front covers. Other molded or extruded thermoplastic articles disclosed herein are selected from the group consisting of pipes for transporting liquids and gases, inner linings for pipes, fuel lines, air break tubes, coolant pipes, air ducts, pneumatic tubes, hydraulic houses, cable covers, cable ties, connectors, canisters, and push-pull cables.

### Materials

### PA612

Salt Preparation: A 10 L autoclave was charged with dodecanedioic acid (2592 g), an aqueous solution containing 78 weight % of hexamethylene diamine (HMD) (1673 g), an aqueous solution containing 28 weight percent acetic acid (30 g), an aqueous solution containing 1 weight percent sodium hypophosphite (24 g), an aqueous solution containing 1 weight percent Carbowax 8000 (10 g), and water (2230 g).

Polymerization process conditions: The autoclave agitator was set to 5 rpm and the contents were purged with nitrogen at 10 psi for 10 minutes. The agitator was then set to 50 rpm, the pressure control valve was set to 1.72 MPa (250 psi), and the autoclave was heated. The pressure was allowed to rise to 1.72 MPa at which point steam was vented to maintain the pressure at 1.72 Mpa. The temperature of the contents was allowed to rise to 240° C. The pressure was then reduced to 0 psig over about 45 minutes. During this time, the temperature of the contents rose to 255° C. The autoclave pressure was reduced to 5 psia by applying vacuum and held there for approximately 20 minutes. The autoclave was then pressurized with 50 psi nitrogen and the molten polymer was extruded into strands, quenched with cold water and cut into pellets.

The polyamide obtained had an inherent viscosity (IV) of 0.94 dl/g. The polymer had a melting point of 218° C., as measured by differential scanning calorimetry (DSC).

### PA614

A 10 L autoclave was charged with tetradecanedioic acid (2690 g), an aqueous solution containing 76 weight % of hexamethylene diamine (HMD) (1602 g), an aqueous solution containing 28 weight percent acetic acid (30 g), an aqueous solution containing 1 weight percent sodium hypophosphite (35 g), an aqueous solution containing 1 weight percent Carbowax 8000 (10 g), and water (2210 g). The process conditions were the same as that described above for PA612.

The polyamide obtained had an inherent viscosity (1V) of 1.15 dl/g. The polymer had a melting point of 213° C., as measured by differential scanning calorimetry (DSC).

### PA 616

Salt Preparation and polymerization: A 10 L autoclave was charged with hexadecanedioic acid (2543 g), an aqueous solution containing 76 weight % of hexamethylene diamine (HMD) (1366 g), an aqueous solution containing 1 weight percent sodium hypophosphite (33 g), an aqueous solution containing 1 weight percent Carbowax 8000 (10 g), and water (2630 g). The process conditions were the same as that described above for PA612.

The polyamide obtained had an inherent viscosity (IV) of 1.18 dl/g. The polymer had a melting point of 207° C., as measured by differential scanning calorimetry (DSC).

### PA 618

A 10 L autoclave was charged with octadecanedioic acid (2610 g), an aqueous solution containing 76 weight % of hexamethylene diamine (HMD) (1278 g), an aqueous solution containing 1 weight percent sodium hypophosphite (33 g), an aqueous solution containing 1 weight percent Carbowax 8000 (10 g), and water (2610 g). The process conditions were the same as that described above for PA612.

The polyamide obtained had an inherent viscosity (IV) of 0.96 dl/g. The polymer had a melting point of 192° C., as measured by differential scanning calorimetry (DSC).

### PA612/614 70/30 Copolymer

PA612/614 70/30 copolymer was prepared by the following process: A 10 L autoclave was charged with dodecanedioic acid (1771 mg), tetradecanedioic acid (852 g), an aqueous solution containing 76 weight % of hexamethylene diamine (HMD) (1693 g), an aqueous solution containing 28 weight percent acetic acid (22 g), an aqueous solution containing 1 weight percent sodium hypophosphite (35 g), an aqueous solution containing 1 weight percent Carbowax 8000 (10 g), and water (2180 g). The process conditions were the same as that described above for PA612. The polyamide obtained had an inherent viscosity (IV) of 1.10.

PA612/614 50/50 copolymer and PA612/614 30/70 copolymer where prepared by adjusting the mole ratio the diacids.

### PA 614/616 50/50 Copolymer

A 10 L autoclave was charged with tetradecanedioic acid (1189 g), hexadecanedoic acid (1317 g), an aqueous solution containing 78.4 weight % of hexamethylene diamine (HMD) (1374 g), an aqueous solution containing 28 weight percent acetic acid (14 g), an aqueous solution containing 1 weight percent sodium hypophosphite (33 g), an aqueous solution containing 1 weight percent Carbowax 8000 (10 g), and water (2620 g). The process conditions were the same as that described above for PA614.

The copolyamide obtained had an inherent viscosity (IV) of 1.04 dl/g. The polymer had a melting point of 185° C., as measured by differential scanning calorimetry (DSC).

### PA 614/616 70/30 Copolymer

A 10 L autoclave was charged with tetradecanedioic acid (1688 g), hexadecanedoic acid (802 g) an aqueous solution containing 78.4 weight % of hexamethylene diamine (HMD) (1394 g), an aqueous solution containing 28 weight percent acetic acid (14 g), an aqueous solution containing 1 weight percent sodium hypophosphite (33 g), an aqueous solution containing 1 weight percent Carbowax 8000 (10 g), and water (2615 g). The process conditions were the same as that described above for PA614.

The copolyamide obtained had an inherent viscosity (IV) of 1.04 dl/g. The polymer had a melting point of 200° C., as measured by differential scanning calorimetry (DSC).

### PA 616/618 (47/53) Copolymer

A 10 L autoclave was charged with hexadecane dioic acid (1160 g), octadecanedioic acid (1419 g), an aqueous solution containing 78.4 weight % of hexamethylene diamine (HMD) (1280 g), an aqueous solution containing 28 weight percent acetic acid (14 g), an aqueous solution containing 1 weight percent sodium hypophosphite (33 g), an aqueous solution containing 1 weight percent Carbowax 8000 (10 g), and water (2460 g). The process conditions were the same as that described above for PA616.

The co-polyamide obtained had an inherent viscosity (IV) of 1.04 dl/g. The polymer had a melting point of 185° C., as measured by differential scanning calorimetry (DSC).

For making other PA616/618 compositions, the amount of hexadecanedioic acid and octadecanedioic acid were adjusted to achieve the desired mole ratio

### Melt Blending

PA612:614 cube blend was prepared by pre-blending 2392 g of PA612 pellets and 1108 g of PA614 pellets.

PA614:616 70/30 cube blend was prepared by pre-blending 2396 g of PA614 and 1104 g of PA616. Melt blending was performed as part of the injection molding process using a Nissei 180 ton Injection molding machine. The pre-blended polymer pellets were fed to the injection molding machine. The barrel temperature profile was 220° C. at the feed port to 240° C. at the nozzle. The melt blended polymer was then molded into test pieces per ASTM D 638 for specification. The mold cavity included ASTM D638 type IV 3.2 mm thick tensile bars and type V 3.2 mm thick tensile bars. Mold temperature was 70° C. Molded bars were ejected from the cavity and stored in dry-as-molded condition in vacuum sealed aluminum foiled bags until ready for testing.

### Methods

### Melting Point

Herein melting points were as determined with DSC at a scan rate of 10° C./min in the first heating scan, wherein the melting point is taken at the maximum of the endothermic peak.

### Inherent Viscosity

Inherent viscosity (IV) was measured on a 0.5% solution of copolyamide in m-cresol at 25° C.

### Physical Properties Measurement

Polymers obtained from single preparation batches or multiple preparation batches (2 to 3 batches) were cube blended, dried and then injection molded into test bars. Tensile properties at 23 C were measured per ASTM D638 specification using an Instron tensile tester model 4469. Yield stress and tensile modulus were measured using 115 mm (4.5 in) long and 3.2 mm (0.13 in) thick type IV tensile bars per ASTM D638-02a test procedure with a crosshead speed of 50 mm/min (2 in/min). Crosshead speed was 50 mm/min. Tensile properties at 125 C were measured using a heating oven installed on the test machine with grips located inside the oven. Shorter ASTM D638 type V bars were used to accommodate higher elongation inside the oven. Crosshead speed was 250 mm/min. Tensile modulus at 125 C was recorded. Flexural modulus was measured using 3.2 mm (0.13 in) thick test pieces per ASTM D790 test procedure with a 50 mm (2 in) span, 5 mm (0.2 in) load and support nose radii and 1.3 mm/min (0.05 in/min) crosshead speed.

### DMA Test Method

Dynamic mechanical analysis (DMA) test was done using TA instruments DMA Q800 equipment. Injection molded test bars nominally measuring 18 mm×12.5 mm×3.2 mm were used in single cantilever mode by clamping their one end. The bars were equilibrated to −140° C. for 3 to 5 minutes, and then DMA test was carried out with following conditions: temperature ramping up from −140° C. to +150° C. at a rate of 2 degrees C./min, sinusoidal mechanical vibration imposed at an amplitude of 20 micrometers and multiple frequencies of 100, 50, 20, 10, 5, 3 and 1 Hz with response at 1 Hz selected for determination of storage modulus (E) and loss modulus (E″) as a function of temperature. Tan delta was computed by dividing the loss modulus (E″) by the storage modulus (E′).

### Salt Resistance Characterization

The method for stress crack resistance is based on ASTM D1693 which provides a method for determination of environmental stress-cracking of ethylene plastics in presence of surface active agents such as soaps, oils, detergents etc. This procedure was adapted for determining salt stress cracking resistance of copolyamides to salt solutions as follows.

Rectangular test pieces measuring 50 mm×12 mm×3.2 mm were used for the test. A controlled nick was cut into the face of each molded bar as per the standard procedure, the bars were bent into U-shape with the nick facing outward, and positioned into brass specimen holders as per the standard procedure. At least five bars were used for each copolymer. The holders were positioned into large test tubes.

The test fluid used was 50 weight percent zinc chloride solution prepared by dissolving anhydrous zinc chloride into water in 50:50 weight ratio. The test tubes containing specimen holders were filled with freshly prepared salt solution fully immersing the test pieces such that there was at least 12 mm of fluid above the top test piece. The test tubes were positioned upright in a circulating air oven maintained at 50° C. Test pieces were periodically examined for development of cracks. After 7-9 days of continued immersion, test pieces were withdrawn from the zinc chloride solution and without wiping, dried in an oven at 50° C. for another 24 hours. Time to first observation of failure in any of the test pieces was recorded.

### Examples and Comparative Examples

Table 1 lists the properties of homopolymers PA612, PA 614, PA 616 and PA 618.

Table 2-4 lists the properties of polyamide resin blends comprising two different homopolyamides in Examples 1-3. As comparative examples, listed are various copolymers having the same repeat units as present in the different homopolyamides.

Melt blends of Examples 1 and 2 exhibit storage modulus and tensile modulus, at 125° C., that are significantly higher than that of the copolyamides having the same repeat units as the homopolymers and at the same ratio. This indicates that the melt blends have an unexpected improved high temperature (125° C.) modulus as compared to the copolymers.

Example 3 (PA616:PA618, 70:30) also shows improved Storage modulus and tensile modulus at 125° C. as compared to that of a copolyamide (PA616/6PA618 47/53) However, the ratios of repeat units of the homopolymers are not the same. Thus, more data would be needed to confirm the improve storage and tensile modulus.

TABLE 1
Properties of PA 612, PA614, PA616 and PA 618 homopolyamides

| Example | C1 | C2 | C3 | C4 |
|---|---|---|---|---|
| Polymer | PA612 | PA614 | PA616 | PA 618 |

DSC data

| | | | | |
|---|---|---|---|---|
| Melting point (° C.) | 218 | 213 | 207 | 192 |
| Heat of fusion (J/g) | 65 | 62 | 65 | 67 |
| Freezing point (° C.) | 188 | 179 | 180 | 164 |
| Delta T (MP − FP) (° C.) | 40 | 34.2 | 27 | 28 |

DMA data

| | | | | |
|---|---|---|---|---|
| Storage modulus, 23° C. (MPa) | 1988 | 1781 | 1473 | 1355 |
| Storage modulus, 125° C. (MPa) | 362 | 323 | 280 | |
| Tan delta Peak Temp (° C.) | 52.8 | 59 | 60 | 53 |
| Tan delta peak value | 0.11 | 0.11 | 0.11 | 0.12 |

Mechanical properties

| | | | | |
|---|---|---|---|---|
| TS, 23° C. (MPa) | 58.5 | 52 | 50 | 45 |
| Flex Modulus (Mpa) | | 1938 | 1781 | 1475 |
| TM, 23° C. (MPa) | 2000 | 1805 | 1697 | 1534 |
| TM, 125° C. (MPa) | 286 | 267 | 243 | |

Salt stress crack resistance

| | | | | |
|---|---|---|---|---|
| Hours (h) to failure at 50° C. | 3 | >95, failure at | No failures | No failures |
| | | 167 h^{a} | to 191 h, | to 191 h and |
| | | | failure after | 24 h drying |
| | | | 24 h drying | |

^{a}no observation available between 95 h and 167 h

TABLE 2
PA612/614 Copolymers and Melt blends

| Example | C5 | C6 | C7 | 1 |
|---|---|---|---|---|
| Polymer Type | Copolymer | Copolymer | Copolymer | Melt blend |
| Polymer Composition | PA612/614 | PA612/614 | PA612/614 | PA612:PA614 |
| | 70/30 | 50/50 | 30/70 | 70:30 |
| Melting point (° C.) | 205 | 195 | 197 | 217 |

DMA data

| | | | | |
|---|---|---|---|---|
| Storage modulus, 23° C. (MPa) | 1720 | 1676 | 1587 | 1774 |
| Storage modulus, 125° C. (MPa) | 242 | 201 | 206 | 278 |
| Tan delta | 58 | 54 | 56 | 57 |
| Tan delta peak value | 0.14 | 0.16 | 0.15 | 0.13 |

Mechanical properties

| | | | | |
|---|---|---|---|---|
| Tensile Strength, 23° C. (MPa) | 56 | 52 | 52 | 58 |
| Flex Modulus (Mpa) | 1889 | 1791 | 1640 | 2067 |
| Tensile modulus, 23° C. (MPa) | 1688 | 1528 | 1567 | 1757 |
| Tensile modulus, 125° C. (MPa) | 210 | 146 | 166 | 258 |

Salt stress crack resistance

| | | | | |
|---|---|---|---|---|
| Hours (h) to failure at 50° C. | 23.5 | 27.5 | 71.5 | 26.5 |

TABLE 3
PA614/616 Copolymers and Melt blends

| Example | C4 | C5 | 2 |
|---|---|---|---|
| Polymer Type | Copolymer | Copolymer | Melt blend |
| Polymer Composition | PA614/616 | PA614/616 | PA614:616 |
| | 70/30 | 50/50 | 70:30 |
| Melting point (° C.) | 200 | 185 | 211 |

DMA data

| | | | |
|---|---|---|---|
| Storage modulus, 23° | 1431 | 1446 | 1568 |
| C. (MPa) | | | |
| Storage modulus, 125° | 215 | 173 | 227 |
| C. (MPa) | | | |
| Tan delta | 56 | 53 | 56 |
| Tan delta peak value | 0.12 | 0.13 | 0.13 |

Mechanical properties

| | | | |
|---|---|---|---|
| Tensile Strength, 23° C. | 48 | 49 | 53 |
| (MPa) | | | |
| Flex Modulus (Mpa) | 1609 | 1660 | 1837 |
| Tensile modulus, 23° C. | 1513 | 1578 | 1632 |
| (MPa) | | | |
| Tensile modulus, 125° | 199 | 162 | 230 |
| C. (MPa) | | | |

Salt stress crack resistance

| | | | |
|---|---|---|---|
| Hours (h) to failure | >95, failure at | >95, failure at | 166.5 |
| at 50° C. | 167 h ^{a} | 167 h ^{a} | |

^{a} no observation available between 95 h and 167 hour

TABLE 4
PA616/618Copolymers and Melt blends

| Example | C6 | C7 | C8 | 3 |
|---|---|---|---|---|
| Polymer Type | Copolyamide | Copolyamide | Copolyamide | Melt Blend |
| Polymer Composition | PA616/618 | PA616/618 | PA616/618 | PA616:PA618 |
| | 90/10 | 47/53 | 10/90 | (70:30) |
| Melting point (° C.) | 204 | 185 | 191 | 207 |

DMA data

| | | | | |
|---|---|---|---|---|
| Storage modulus, 23° C. (MPa) | 1432 | 1356 | 1317 | 1164 |
| Storage modulus, 125° C. (MPa) | 251 | 153 | 178 | 183 |
| Tan delta | 58 | 56 | 54 | 56 |
| Tan delta peak value | 0.11 | 0.13 | 0.12 | 0.13 |

Mechanical properties

| | | | | |
|---|---|---|---|---|
| Tensile Strength, 23° C. (MPa) | 50 | 45 | 44 | 53 |
| Flex Modulus (Mpa) | 1743 | 1514 | 1477 | 1628 |
| Tensile modulus, 23° C. (MPa) | 1695 | 1517 | 1468 | 1469 |
| Tensile modulus, 125° C. (MPa) | 225 | 137 | 173 | 188 |

Salt stress crack resistance

| | | | | |
|---|---|---|---|---|
| Hours (h) to failure at 50° C. | No failures to | NA | No failures to | No failures to |
| | 191 h, failure | | 191 h and 24 h | 239 h and 24 h |
| | after 24 h | | drying | drying |
| | drying | | | |

NA = not available

We claim:

1. A polyamide resin blend consisting essentially of:
a) 80 to 20 mole percent repeat units of a first homopolyamide; and
b) 20 to 80 mole percent repeat units of a second homopolyamide that is different from said first homopolyamide;
wherein said first and second homopolyamides are selected from the group consisting of poly(hexamethylene dodecanediamide), poly(hexamethylene tetradecanediamide), poly(hexamethylene hexadecanediamide) and poly(hexamethylene octadecanediamide).

2. The polyamide resin blend of claim 1 wherein said first homopolyamide is poly(hexamethylene dodecanediamide) and
said second homopolyamide is poly(hexamethylene tetradecanediamide).

3. The polyamide resin blend of claim 1 wherein said first homopolyamide is poly(hexamethylene tetradecanediamide) and said second homopolyamide is poly(hexamethylene hexadecanediamide).

4. The polyamide resin blend of claim 1 wherein said first homopolyamide is poly(hexamethylene hexadecanediamide) and said second homopolyamide is poly(hexamethylene octadecanediamide).

5. The polyamide resin blend of claim 1 wherein said first homopolyamide is 70 to 30 weight percent; and said second homopolyamide is 30 to 70 weight percent.

6. A thermoplastic composition comprising:
A) 30 to 90 weight percent of a polyamide resin blend consisting essentially of (a) 80 to 20 mole percent repeat units of a first homopolyamide; and (b) 20 to 80 mole percent repeat units of a second homopolyamide; wherein said first and second homopolyamides are selected from the group consisting of poly(hexamethylene dodecanediamide), poly(hexamethylene tetradecanediamide), poly(hexamethylene hexadecanediamide) and poly(hexamethylene octadecanediamide).
B) 0 to 30 weight percent of one or more polymeric tougheners;
C) 0 to 10 weight percent of one or more functional additives; and
D) 0 to 60 weight percent of one or more reinforcing agent;
wherein the weight percent of (A), (B), (C) and (D) are based on the total weight of the thermoplastic composition and at least one component of the group consisting of (B), (C), or (D) is present in at least 0.1 weight percent.

7. A molded or extruded article comprising the thermoplastic composition of claim 6.
